(19) United States
(12) Patent Application Publication
(10) Pub. No.: US 2026/0200667 A1
(43) Pub. Date: Jul. 16, 2026

(54) Chute Device And Assembly For Collecting Lawn Debris

(71) Applicant: Nelson Andrews, Hyannis, MA (US)

(72) Inventor: Nelson Andrews, Hyannis, MA (US)

(21) Appl. No.: 19/431,614

(22) Filed: Dec. 23, 2025

Related U.S. Application Data
(60) Provisional application No. 63/737,966, filed on Dec. 23, 2024.

(51) Int. Cl. B65F 1/10; B65F 1/14

(52) U.S. Cl. CPC B65F 1/10; B65F 1/1405; B65F 2210/162; B65F 2240/138

(57) ABSTRACT

A chute device for collecting debris, such as lawn debris, and an assembly comprising the chute device and a container are provided. Any suitable container, such as a trash barrel, can be used.

The chute device comprises; a) a main body panel member; b) an upper rim and first and second side rims that extends downwardly from the upper rim, wherein the side rims comprise handles in their lower sections, and c) a lower rim, wherein at least one attachment clip extends downwardly from the lower rim, and at least one attachment clip extends downwardly from the rear surface of the panel member so the chute device can be fastened to a container. In one preferred embodiment, the attachment clip on the rear surface of the panel member includes a flexible handle portion.

### CROSS-REFERENCE TO RELATED APPLICATIONS

The application claims the benefit of U.S. Provisional Patent Application No. 63/737,966 filed Dec. 23, 2024, the entire disclosure of which is hereby incorporated by reference.

### BACKGROUND OF THE INVENTION

### Field of the Invention

The present invention relates generally to a chute device for collecting debris such as, for example, leaves, grass and shrubbery clippings, pine needles, branches, garden waste, and the like. More particularly, the invention relates to chute devices having a main body panel member that can be removably fastened to containers such as, for example, trash barrels. The invention also encompasses chute devices and container assemblies. The chute device of the invention is lightweight and durable. Both residential homeowners and commercial landscapers can easily handle and use the chute device to clean lawn debris.

### Brief Review of the Related Art

At many residential and commercial sites, lawn debris needs to be continuously collected and disposed of. Both residential homeowners and commercial landscapers use different means for collecting such debris.

For example, yard waste such as, for example, leaves and grass clippings, may be removed by raking the waste into piles and placing the waste in trash bags. Additionally, yard waste may be removed by raking the waste into piles and placing the waste in a container or bag, such as one well-known in the field. Alternatively, yard waste may be blown into piles by a machine, such as a leaf blower and then placed in trash bags, disposal bags, or other containers. One problem with such methods is that the user must bend over to place the yard waste in the container, and the user can strain their back muscles when doing such labor. In recent years, to address these problems, different leaf collecting devices have become popular and are described in the patent literature.

For example, Weathers et al., U.S. Pat. No. 6,708,742 discloses a chute apparatus for collecting leaves and debris includes: (a) an upper chute portion having an open front portion, the chute portion including a back portion with a front end that is wider than its rear end, and two smaller, matching chute sides attached to either side of the back chute portion; and (b) an open-ended lower channel portion connected to the chute portion. To use the chute apparatus, the channel portion is placed into an empty trash receptacle. The chute may include its own close-fitting trash receptacle, or a conventional trash receptacle may be used.

Bergell, U.S. Pat. No. 6,983,965 discloses a chute made of a generally rigid material. The chute has a central section and two side sections coupled to the central section. The chute is adapted to be held in an open orientation. The input ends and L-shaped cut outs fit within a trash container and the remainder of the chute extend outwardly from the trash container. In this manner, a user may sweep leaves and other debris onto the central section of the chute between the side sections and into the trash container.

Wallek, U.S. Pat. No. 7,219,705 discloses a leaf bag system for use with receptacles. The system comprises a funnel-providing system of a neck portion and a funnel portion. The funnel-providing portion comprises a flexible material that forms a leading edge of the funnel portion that curves back onto itself to form a funnel having a wide leading edge and a narrower base of the funnel portion. The narrower base of the funnel portion is connected to the neck portion. A gripping element extends over at least a length of the neck portion, the gripping portion capable of gripping an element such as the end of a plastic bag.

Genotti, III, U.S. Pat. No. 10,029,849 discloses an attachable scoop that is affixed to a trash can for collecting yard debris. Once the attachment is clipped onto the trash can's top rim, the attachment and can are placed in a flat position along the ground. In order to prevent leaves or other debris from sliding outside of the trash can, the attachment provides a fold down edge at the beginning of the scoop as well as a raised portion that prevents the leaves or other debris from escaping the can. The yard debris is collected by pushing the debris along the scoop surface and into the trash can.

Sweeney, U.S. Pat. No. 10,798,884 discloses a lawn debris collection device for use with a trash bag. The lawn debris collection device holds the trash bag in an open position during the collection of debris. The debris is moved to the upwind side of the lawn debris collection device where the debris remains trapped until the debris is placed in the trash bag. The lawn debris collection device folds flat when not in use.

However, conventional devices for collecting lawn debris have some drawbacks. For example, some devices are not durable and cannot handle the weight of the lawn debris. Additionally, a user may need to fully bend over to use the device and can strain his/her back muscles. Such devices are cumbersome and time-consuming to use. Further, some devices require stakes in the ground to hold down the containers. Further, some devices are permanently affixed to the barrel and cannot be removed or transferred to different barrels. Other scoops or chutes do not stay attached to the barrel or container and easily fall off. As such, landscapers can spend more time fixing a problem with the scoop or barrel and less time doing the necessary landscaping work.

Thus, there is a need for an improved chute device and assembly for collecting debris, particularly lawn debris such as, for example, leaves, grass and shrubbery clippings, pine needles, branches, garden waste, and the like. The chute device should be lightweight and durable. A residential or commercial landscaper should be able to efficiently use the chute device and assembly in different ways. The present invention provides such an improved chute device and assembly. Other advantages, features, and benefits of the present invention are described further below.

### SUMMARY OF THE INVENTION

The present invention generally relates to a chute device for collecting debris and an assembly comprising the chute device and a container. Any suitable container can be used in accordance with the present invention. In one preferred embodiment, a trash barrel is used. Preferably, the chute and assembly are used for collecting lawn debris such as, for example, leaves, grass and shrubbery clippings, pine needles, branches, garden waste, and the like. The chute device of the invention is lightweight and durable. Both residential homeowners and commercial landscapers can easily handle and use the chute device to clean lawn debris.

In one preferred embodiment, the chute device comprises; a) a main body panel member having an upper portion and a lower portion, wherein the panel member has a front surface and a rear surface; b) an upper rim extending along the upper portion of the panel member and a first side rim that extends downwardly from the upper rim, and an opposing second side rim that extends downwardly from the upper rim, the first and second side rims each having upper and lower sections, wherein the lower section of the first side rim comprises a first handle and the lower section of the second side rim comprises a second handle; and c) a lower rim extending along the lower portion of the panel member, wherein at least one attachment clip extends downwardly from the lower rim, and at least one attachment clip extends downwardly from the rear surface of the panel member so that the chute device can be fastened to a container for receiving the debris collected by the chute device.

The lower rim preferably has four attachment clips, and the rear surface of the panel member preferably has one attachment clip. In one preferred embodiment, the attachment clip on the rear surface of the panel member includes a flexible handle portion. The attachment clips can be removably fastened to the chute. A debris compactor can be removably fastened to the rear surface of the panel member. The debris compactor can comprise a frame having a front surface and a rear surface, wherein the frame has apertures for diffusing air, and a handle extending from the rear surface. The upper rim can have a hook and each of the first and second side rims can have slots for storing the chute device on a hook, post, or other suitable fastener when it is not being used. Preferably, the container handle is removably fastened to front surface of the panel member of the chute device. The container handle preferably has upper and lower clamping interfaces for clamping the handle to a container such as a trash barrel.

The present invention also provides a chute device and container assembly comprising: a) a chute device for collecting debris, the chute device comprising a main body panel member having an upper portion and a lower portion, wherein the panel member has a front surface and a rear surface; b) an upper rim extending along the upper portion of the panel member and a first side rim that extends downwardly from the upper rim, and an opposing second side rim that extends downwardly from the upper rim, the first and second side rims each having upper and lower sections, wherein the lower section of the first side rim comprises a first handle and the lower section of the second side rim comprises a second handle; c) a lower rim extending along the lower portion of the panel member, wherein at least one attachment clip extends downwardly from the lower rim, and at least one attachment clip extends downwardly from the rear surface of the panel member; and d) a container having inner and outer surfaces, wherein the chute is fastened to the container by the attachment clips, that at least one attachment clip extending downwardly from the lower rim and contacting the inner surface of the container, and the at least one attachment clip extending downwardly from the rear surface of the panel member and contacting the outer surface of the container.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a front perspective view of one embodiment of the chute device of the present invention;

FIG. 2 is a rear perspective view of one embodiment of the chute device of the present invention;

FIG. 3 is a front exploded view of one embodiment of the chute device of the present invention showing the detached debris compactor and container handle;

FIG. 4 is a rear exploded view of one embodiment of the chute device of the present invention showing the detached debris compactor and container handle;

FIG. 5 is a front exploded view of one embodiment of the chute device of the present invention and a container;

FIG. 6 is a rear exploded view of one embodiment of the chute device of the present invention and a container;

FIG. 7 is a side exploded view of one embodiment of the chute device of the present invention and a container;

FIG. 8 is a front perspective view of one embodiment of the chute device of the present invention showing the chute device being installed on a container;

FIG. 9 is a rear perspective view of one embodiment of the chute device of the present invention showing the chute device being installed on a container;

FIG. 10 is a close-up view of one embodiment of the chute device of the present invention showing the chute device being installed on a container;

FIG. 11 is a perspective view of one embodiment of the chute/container assembly of the present invention showing the debris compactor being used in the container;

FIG. 12 is a close-up view of one embodiment of the chute/container assembly of the present invention showing the debris compactor in the container;

FIG. 13 is a front perspective view of one embodiment of the chute/container assembly of the present invention showing the assembly in an inclined position;

FIG. 14 is a side perspective view of one embodiment of the chute/container assembly of the present invention showing the assembly in an inclined position;

FIG. 15 is a perspective view of one embodiment of the chute/container assembly of the present invention showing the container handle attached to the container;

FIG. 16 is a close-up view of one embodiment of the chute/container assembly of the present invention showing the container handle attached to the container;

FIG. 17 is a front perspective view of one embodiment of the chute device of the present invention showing the chute device being installed on a container;

FIG. 18 is a rear perspective view of one embodiment of the chute device of the present invention showing the chute device being installed on a container;

FIG. 19 is a side perspective view of one embodiment of the chute device of the present invention showing the chute device being installed on a container; and

FIG. 20 is a perspective view of one embodiment of the chute/container assembly of the present invention showing the chute device having an attachment clip with a flexible handle portion installed on a container.

### DETAILED DESCRIPTION OF THE INVENTION

The present invention relates generally to a chute device for collecting debris and an assembly comprising the chute device and a container such as, for example, a trash barrel. The following description primarily refers to lawn debris such as, for example, leaves, grass and shrubbery clippings, pine needles, branches, garden waste, and the like. However, it should be understood that the chute device of the present invention can be used for collecting any suitable debris. For example, in addition to lawn debris, the chute device can be used for cleaning up building debris and other waste materials.

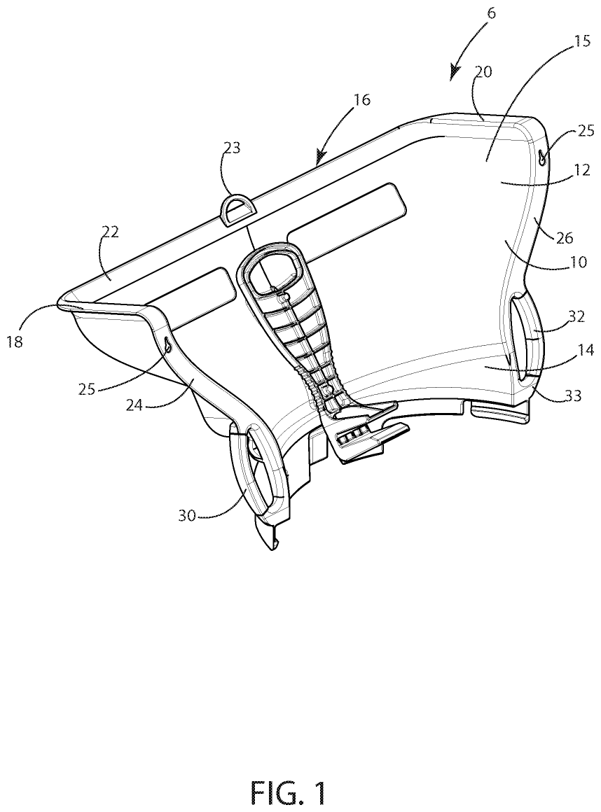

Referring to the Figures, where like reference numerals are used to designate like elements, and particularly FIG. 1, one preferred embodiment of the chute device of the present invention is shown. The chute device, generally indicated at (6), comprises a main body panel member (10). In one preferred embodiment, the chute device (6) is a one-piece integral unit. The chute device (6) can be made from plastic, metal, composite, or any other suitable durable material. The chute device (6) has a generally sloping structure for sliding debris into a container as described further below.

More particularly, in the embodiment shown in FIG. 1, the chute device (6) comprises a main body panel member (10) having an upper portion generally indicated at (12) and a lower portion generally indicated at (14). The main body panel member (10) includes a front surface generally indicated at (15) and a rear surface generally indicated at (17) (not shown in FIG. 1). The front surface is (15) generally concave-shaped. An upper rim (16) extends along the upper portion (12) of the chute (6). The upper rim (16) is generally U-shaped as shown in FIG. 1. The U-shaped upper rim (16) includes a first arm segment (18) and opposing second arm segment (20) that are joined together by a cross-arm segment (22).

A first side rim (24) extends downwardly from the first arm segment (18) of the upper rim (16). An opposing second side rim (26) extends downwardly from the second arm segment (20) of the upper rim (16). The first side rim (24) has a lower section comprising a first handle (30). The opposing second side rim (26) has a lower section comprising a second handle (32). Preferably, the handles (30, 32) have cut-out areas so that a user can slide his/her hands through and grasp them as shown in FIG. 1. In practice, the user can easily grip the handles (30, 32) with their left and right hands and firmly hold onto the chute (6). As further shown in FIG. 1, the lower portion (14) of the chute (6) includes a lower rim (33) extending along the lower portion (14) of the main body panel member (10).

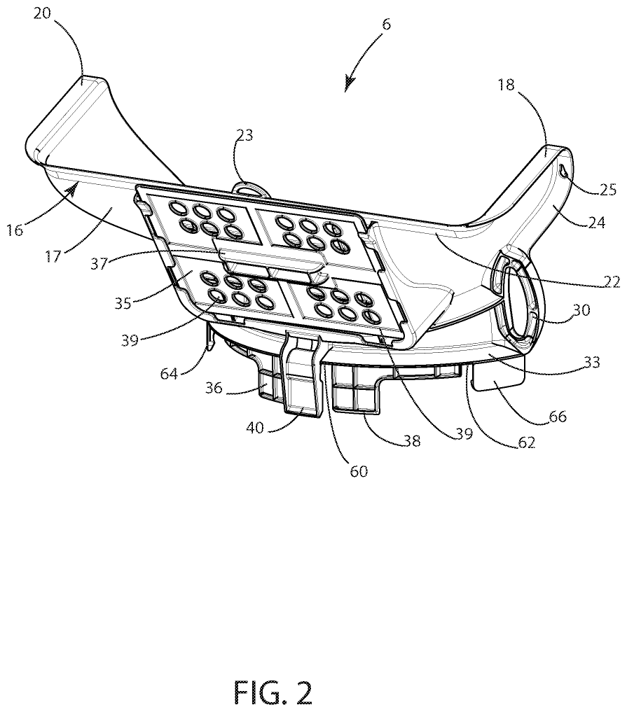

In FIG. 2, the rear surface (17) of the main body panel member (10) is shown. Here, a debris compactor (35) is shown removably fastened to the rear surface (17). The compactor (35) can be removed from the chute (6) and used for pushing down the debris in a container (not shown in FIG. 2) so there is more capacity for debris as described further below. The compacter (35) can include a handle (37) and apertures (39) for managing air flow, which helps make the compactor more effective in compacting the debris.

As shown in FIG. 2, the lower rim (33) of the main body panel member (10) has generally middle (60) and outer regions (62). At least one attachment clip extends downwardly from the middle region (60) of the lower rim (33). In addition, at least one attachment clip extends downwardly from the outer region (62) of the lower rim (33). Further, at least one attachment clip extends downwardly from the rear surface (17) of the main body panel member (10). In the embodiment of FIG. 2, two (2) attachment clips (36, 38) are shown extending from the middle region (60) of the lower rim (33); two (2) attachment clips (64, 66) are shown extending from the outer region (60) of the lower rim (33); and one (1) attachment clip (40) is shown extending from the rear surface (17) of the panel member (12). It is recognized that any suitable number of attachment clips can be used in accordance with the present invention. For example, in other embodiments, seven (7) or nine (9) attachment clips can be used. The attachment clips can also be replaceable as discussed further below.

The attachment clips (36, 38, 40, 64, and 66) extending from the lower rim (33) are fastened to the container for securing the chute (6) to the container which then receives the debris collected by the chute device (6) as described further below. The attachment clips may comprise relatively elastic materials. Plastics having different tensile strength, flex modulus, impact durability, and other properties may be used depending on the desired support strength of the attachment clips. In one particularly preferred embodiment, the attachment clip (40) includes a relatively flexible handle portion (70) as discussed further below. As further shown in FIGS. 1 and 2, the chute device (6) can include a loop (23) and slots (25) or other suitable elements for storing the device when it is not being used. For example, the chute device (6) can be stored on a hook, post, or other suitable fastener in a garage.

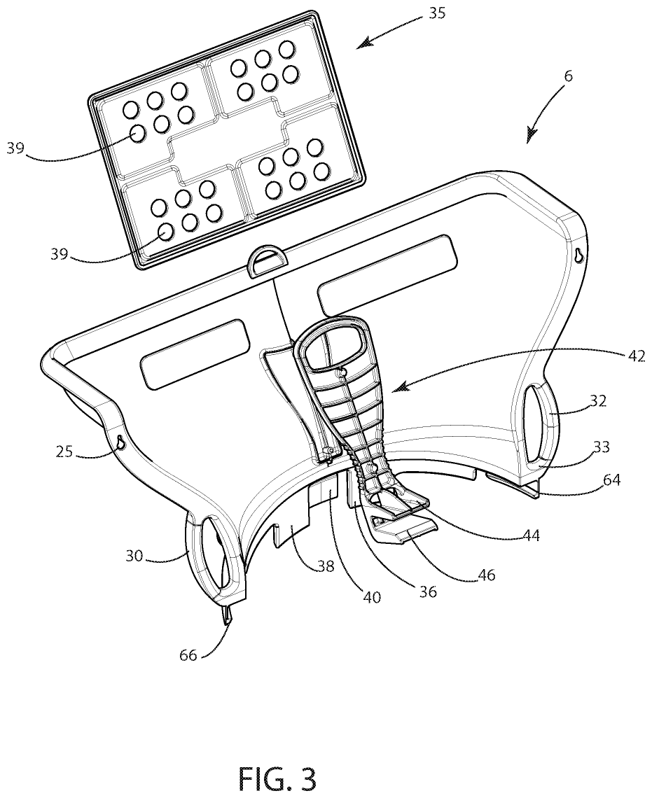

Referring to FIG. 3, a container handle (42) having clamping interfaces (44, 46) is

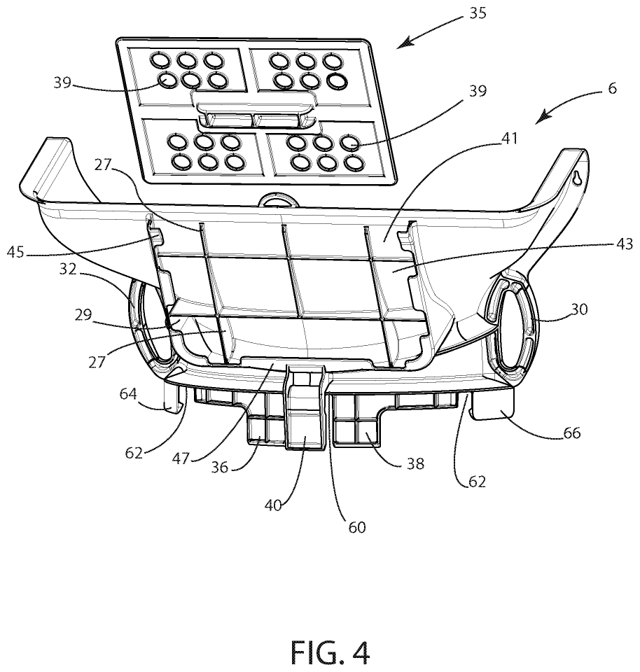

shown removably fastened to the front surface (15) of the main body panel member (10). The container handle (42) can be fastened to a container containing the debris (not shown in FIG. 3) seating and lifting the container as described further below. In FIGS. 3 and 4, the debris compactor (35) is shown being removed from the rear surface (17) of the main body panel member (10). As also shown in FIGS. 3 and 4, the debris compactor (35) can be stored in a compactor frame (41) at the rear of the chute (6) when the compactor is not being used. The frame (41) can have a grid pattern comprising vertical (27) and horizontal (29) extending members with openings (43), and tabs (45) for locking the compactor (35) in place. As further shown in FIG. 4, the attachment clip (40) can be joined to a lower horizontally-extending locking tab (47) on the compactor frame (41). The attachment clip (40) extends downwardly from the lock tab (47). This locking tab (47) also helps keep the compactor (35) secured to the chute (6) when the compactor is not being used.

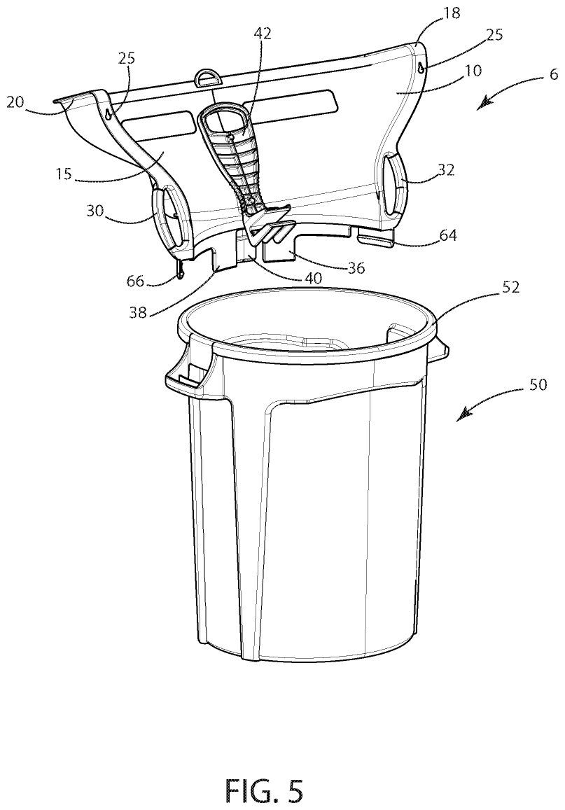

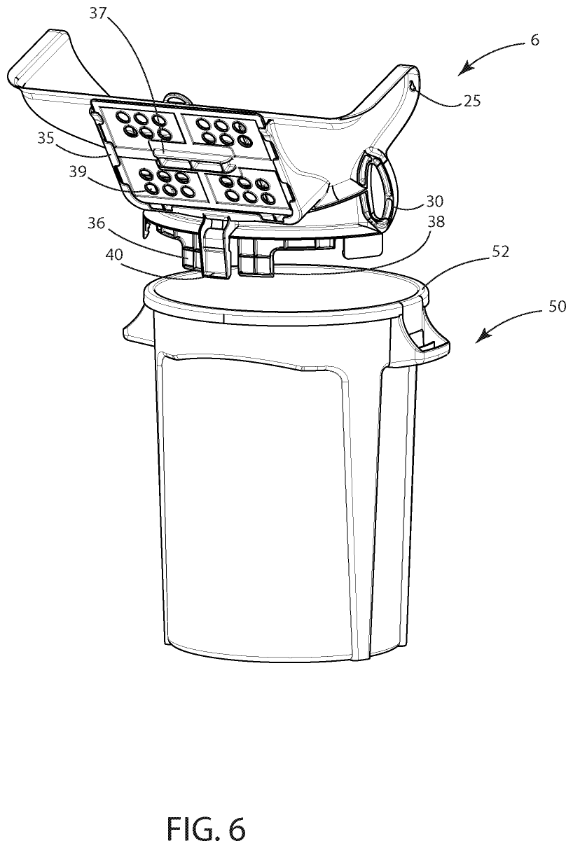

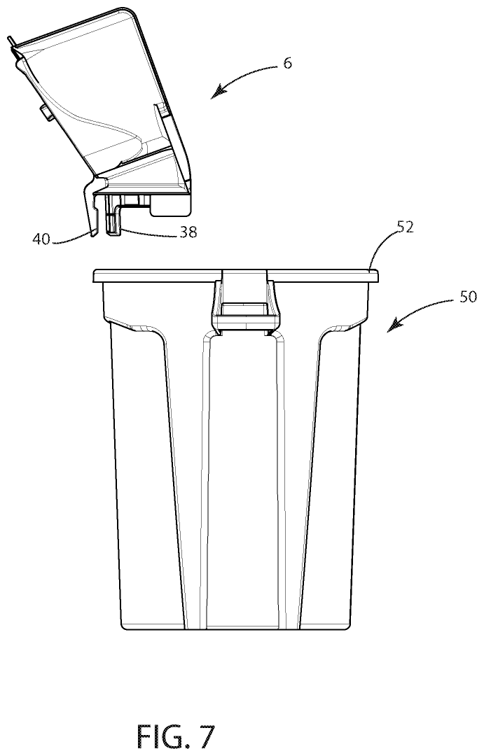

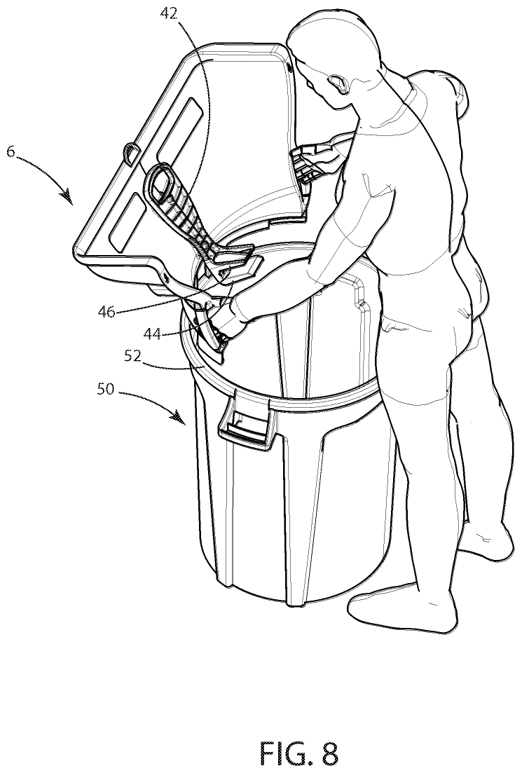

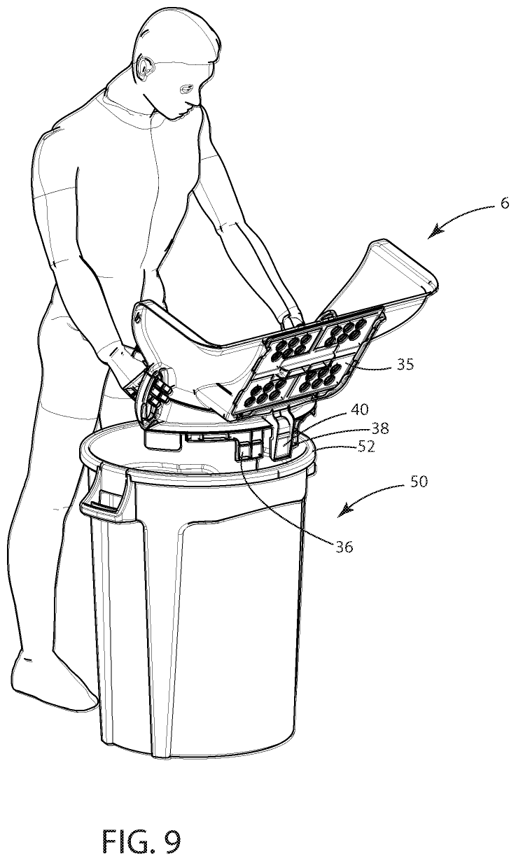

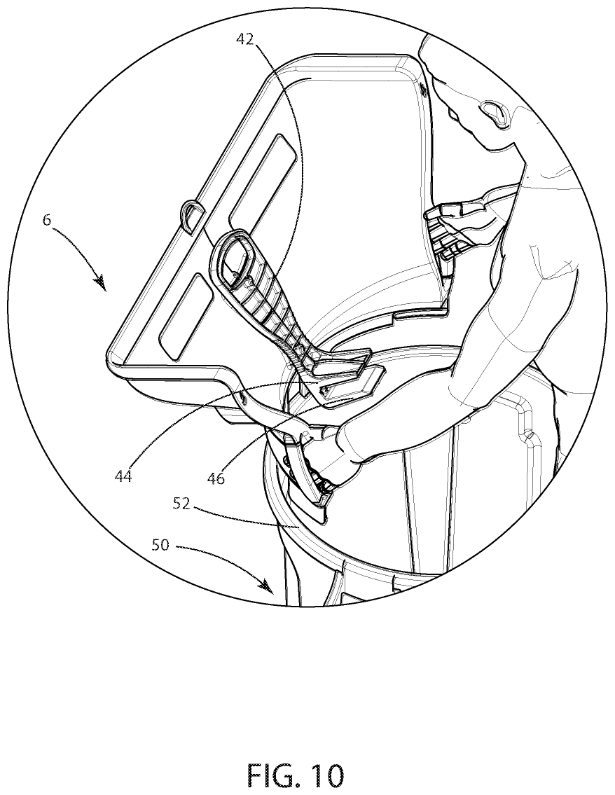

Turning to FIGS. 5-10, the chute device (6) is shown being attached to an uprightly-positioned container (50). Any suitable container (50) can be used in accordance with the present invention. For example, barrels, cans, bins, carts, collapsible and pop-up receptacles, and the like can be used. Trash barrels are typically used. A trash barrel (50) is shown in FIGS. 5-10, and trash barrels are primarily described herein. The container (50) is normally cylindrical with a circular opening. However, other shaped containers (50) can be used in accordance with the present invention including, for example, square, rectangular, triangular, oval, polygonal, and the like shaped containers.

In practice, a person may grasp the handles (30, 32) of the chute (6) and press the chute downwardly until it snaps in place to the upper rim (52) of the trash barrel (50). The handles (30, 32) are ergonomically designed so the user can comfortably and efficiently insert their fingers through the opening, while placing their thumb on the upper surfaces of the handles to hold the chute (6) securely. The position of the attachment clips (36, 38, 40, 64, and 66) around the container (50) help keep the chute (6) firmly secured. As shown in FIGS. 5-10, the container (50) has generally inner (56) and outer (58) surfaces. As discussed above, at least one attachment clip (36, 38. 64, and 66) extends downwardly from the lower rim (33) and is in contact with the inner surface (56) of the container (50), and at least one attachment clip (40) extends downwardly from the rear surface (17) of the panel member (12) and is in contact with the outer surface (58) of the container (50).

In this way, the chute (6) is secured and sits partially within the container (50), and the debris can be conveyed manually or otherwise into the container. Furthermore, the attachment clips (36, 38, 40, 64, and 66) can be removably fastened to the chute (6) in some embodiments. This allows the attachment clips (36, 38, 40, 64, and 66) to be easily replaced if damaged. In other cases, the clips might not be damaged, but it may be desirable to replace the attachment clips (36, 38, 40, 64, and 66) with larger or smaller clips as needed. Replacing the clips could depend upon the size of the trash barrel or other container, where the clips are being fastened.

As the attachment clips (36, 38, 40, 64, and 66) are snapped into place, the lower rim (33) of the chute (6) comes to rest against the seating surface of the trash barrel (50). In this manner, the chute (6) is securely and removably fastened to the trash barrel (50). The chute (6) is not easily dislodged from the container (50). The chute (6) remains tightly fastened to the trash barrel (50) even if the barrel is moved from one place to another.

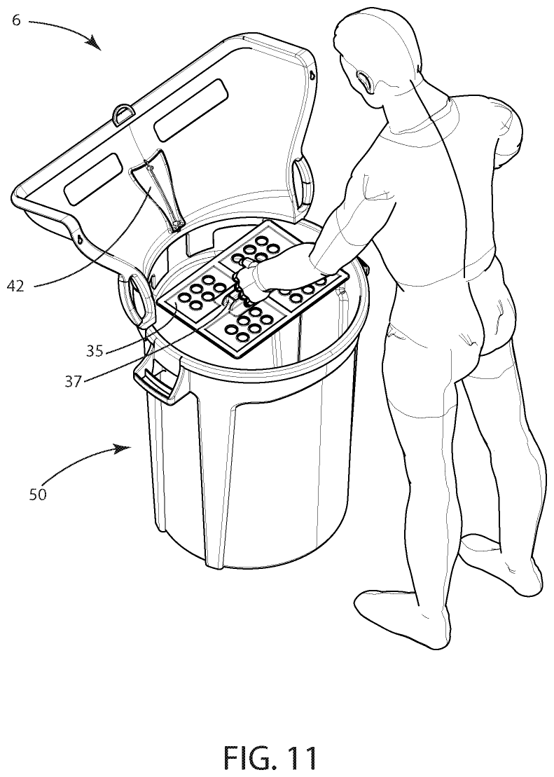

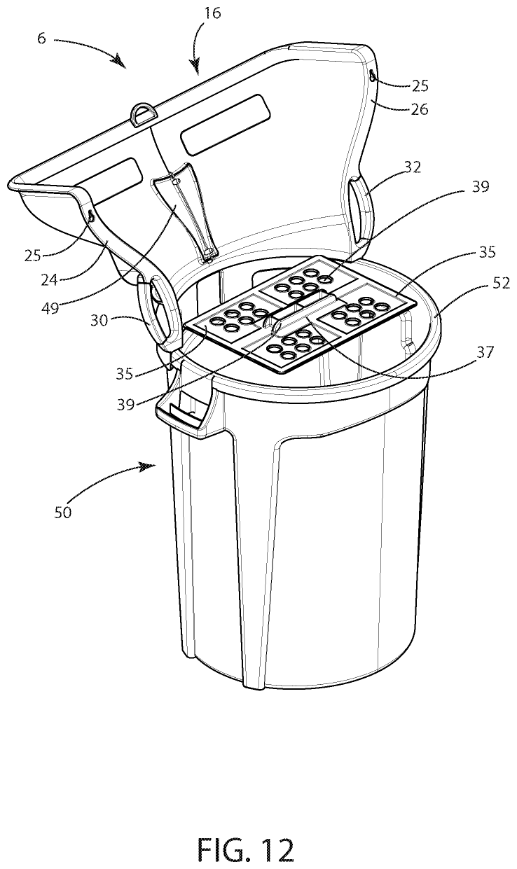

As shown in FIGS. 11 and 12, the compactor (35) can be used to push down debris in the container (50) so there is more room for additional debris in the container. A user can easily grasp the handle (37) and push downwardly to stomp the debris into the container (50) and create more space. Air can diffuse through the apertures (37) to make the debris-compacting process easier. In FIGS. 11 and 12, the compactor (35) is shown having circular openings (39) arrayed in a specific pattern for managing air flow through the compactor. It should be understood, however, that the number, geometry and dimensions of the openings (39) in the compactor (35) can vary in accordance with the present invention. For example, the openings (39) can have square, rectangular, triangular, oval, polygonal, and the like structures.

When the chute (6) is attached to the container, for example a trash barrel (50), the chute/container assembly (55) of this invention can be made to rest upon the ground in an upright position as shown in above-discussed FIGS. 5-12. In this position, the chute/container assembly (55) has excellent dimensional-stability and remains firmly in place during use. As a user works with their hands, rakes, shovels, or otherwise places the debris in the chute (6), it remains firmly locked to the trash barrel (50). A user can lean into the chute/container assembly (55) as they are pushing down leaves and other debris from the chute (6) into the trash barrel (50). Although a user may use a substantial amount of force in this action, the assembly (55) remains upright. The assembly (55) is stable and does not easily topple over. Many users will find this upright and stable balance of the chute/container assembly (55) to be helpful in cleaning up debris.

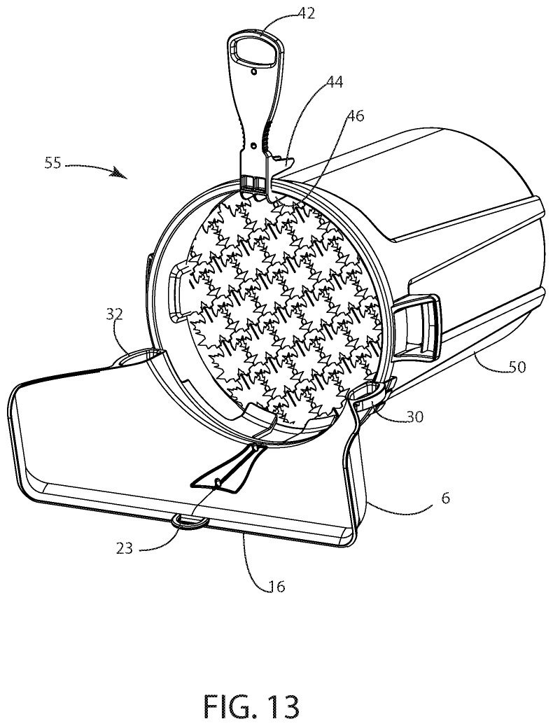

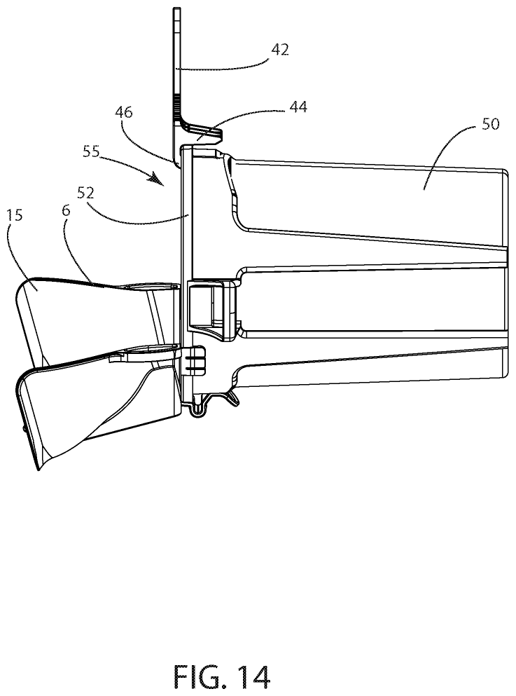

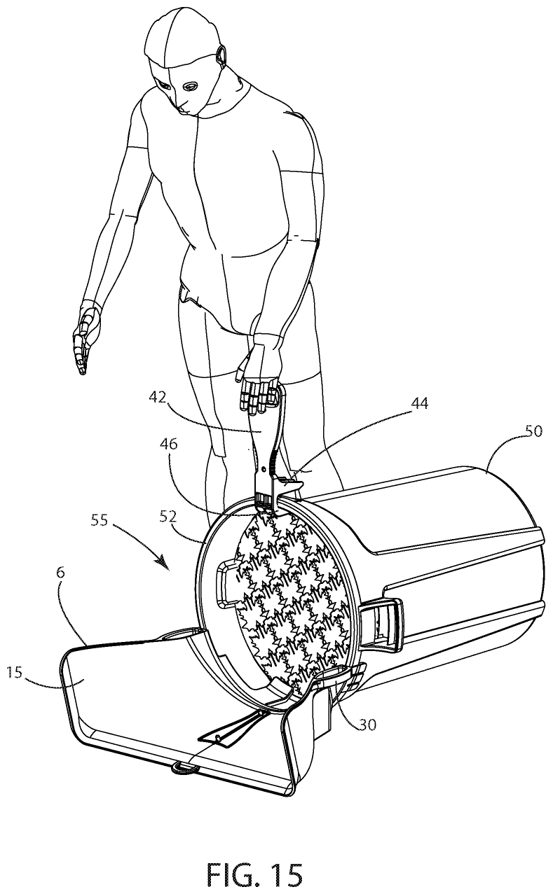

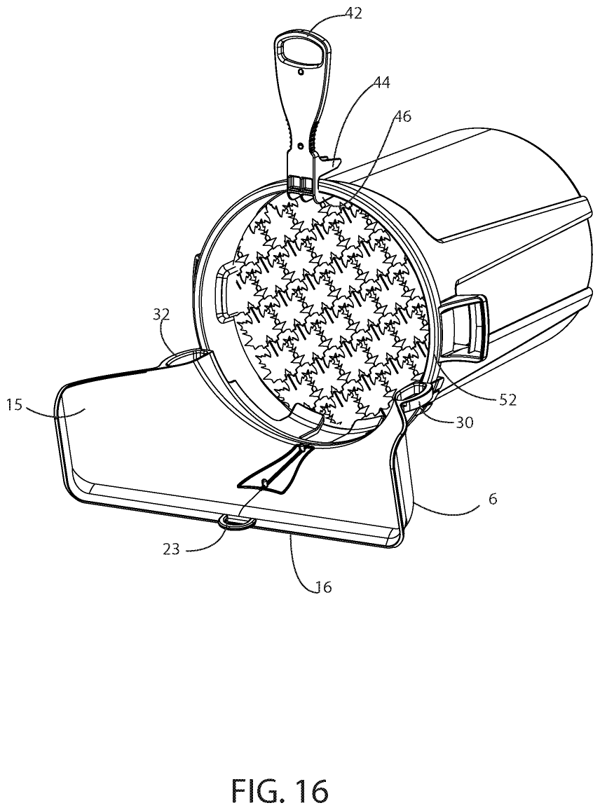

Alternatively, the chute/container assembly (55) can be made to rest upon the ground in an inclined position as shown in FIGS. 13-16. In this position, the chute/container assembly (55) also has excellent dimensional-stability. When a user works with their hands, rakes, shovels, or otherwise places the debris in the chute (6), it remains firmly locked to the trash barrel (50). The chute (6) provides a relatively wide channel for conveying the debris into the trash barrel (50). Likewise, many users will find this angled positioning of the chute/container assembly (55) to be helpful in cleaning up debris. Turning back to FIG. 12, the container handle (42) has been removed and the receiving groove (49) for storing the container handle (42) is shown. In FIGS. 13-16, the container handle (42) is fastened to the container (50) by clamping interfaces (44, 46) is effective for lifting the assembly (55) up and setting the assembly down on the ground surface.

The chute/container assembly (55) of the present invention is ideal for different ground surfaces and the assembly helps to distribute the weight of the debris properly, For example, in some cases, the user will place the assembly (55) on a level and smooth surface such as a well-manicured lawn, When the ground terrain has a level surface, it is ideal for placing the assembly (55) in an upright position, A person can easily convey debris down the chute (6) and into the barrel (50). In this position, the entire bottom surface of the base of the barrel (50) contacts the ground. The base of the barrel (50) provides the sole point of contact with the ground. The assembly (55) has good stability and does not easily tip over.

In other cases, the user will want to place the chute/container assembly (55) on non-level ground surfaces such as hills or rough terrain covered with rocks and sticks. Such extreme non-level surfaces can create an unstable platform for the assembly (55). In such instances, the user may want to place the assembly (55) in a tilted position, wherein the assembly is angled with the ground surface. When the assembly (55) is placed in a tilted position, only a portion of the base of the barrel (50) and chute (6) are in contact with the ground. However, the weight of the debris in the barrel (50) is still well supported by the chute (6) and base portion. The base of the barrel (50) and chute (6) work together to support the barrel (50) in this angled position.

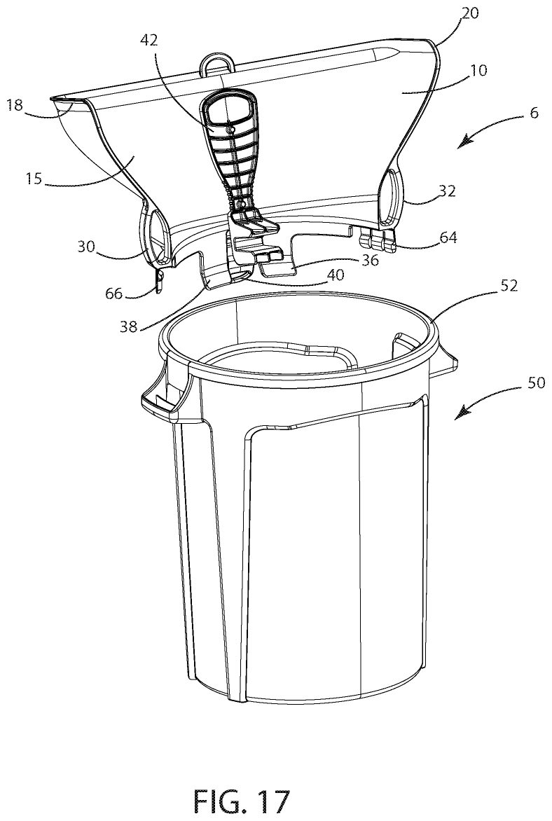

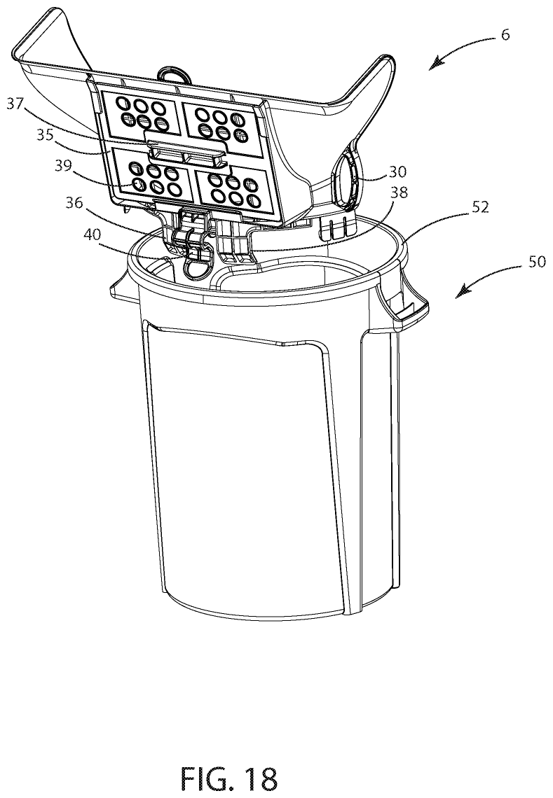

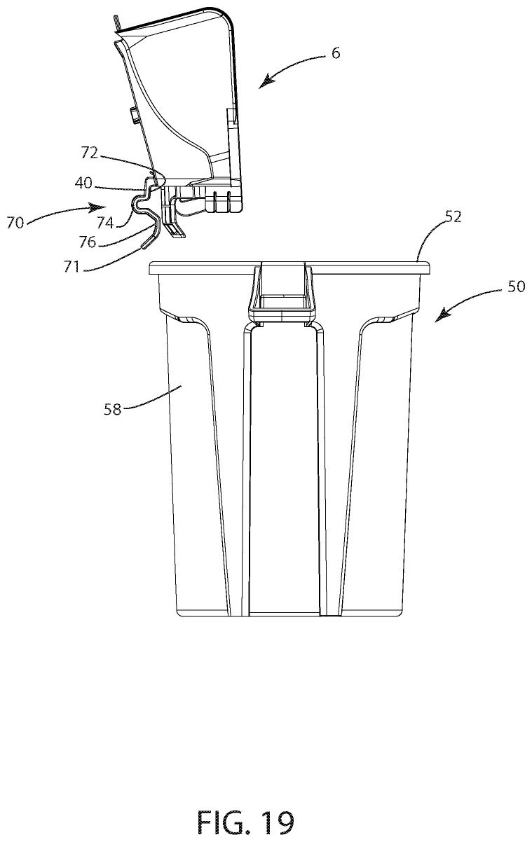

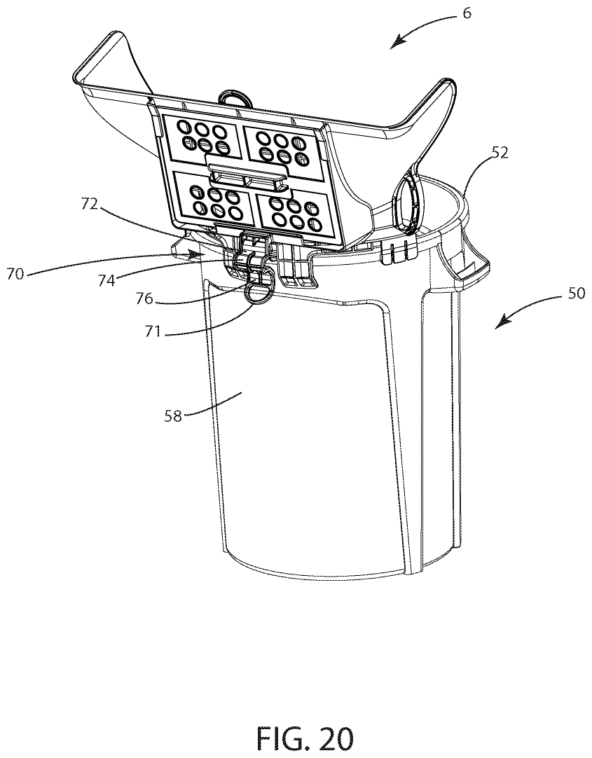

As discussed above, in one particularly preferred embodiment, the attachment clip (40) includes a relatively flexible handle portion generally indicated at (70). Referring to FIGS. 17-20, the flexible handle portion (70) comprises an upper arm segment (72), an intermediate segment (74), and a lower arm segment (76). The upper arm segment (72) is shaped to make contact with the upper rim (52) of the container (50). The upper arm segment (72) is pressed against outer surface (58) of the container (50), particularly the outer surface of the container's rim (52), when the attachment clip (40) is snapped onto the container. In practice, a person may press downwardly on chute device (6) until the attachment clip (40) snaps in place.

The flexible handle (70) has a D-shaped pull-out area (71), and a user can easily insert their hand through this D-shaped area to grasp the handle. When a person pulls on the flexible handle (70), the attachment clip (40) is partially deflected, and the chute device (6) is disengaged from the container (50). More particularly, the lower arm segment (72) disengages and no longer is pressed against the outer surface (58) of the container (50). The lower arm segment (72) is cleared from surface contact with the container (50) and thus may move freely. Thus, a person can easily remove the entire chute device (6) from the container (50) by pulling upwardly on the chute.

The chute device of the present invention present invention provides many advantages over conventional systems. For example, the chute is lightweight and yet durable. Both residential homeowners and commercial landscapers can easily handle and use the chute. The chute has distinctive ergonomic handles that allow a landscaper to grasp the chute comfortably. The chute device attaches directly to any suitable container such as, for example, a conventional trash barrel. The chute device is durable and can be used for loading heavy amounts of lawn debris into the container. For example, the chute device can be used to load piles of wet leaves. As discussed above, the attachment clips can be removably fastened to the chute in some embodiments. In this way, the attachment clips can be replaced as needed. Furthermore, the chute device includes a unique debris compactor which is removably fastened to the chute and can be used for compacting the leaves and other debris in the container. The chute device also includes a distinctive container handle that can be fastened to the trash barrel or other container for lifting up and setting the chute/container assembly down. As also discussed above, the chute/container assembly has excellent dimensional-stability and can be used on a variety of ground surfaces.

It should be understood that the terms, “first”, “second”, “third” “top”, “bottom”, “upper”, “lower”, “upwardly”, “downwardly”, “above” “below”, “right”, “left”, and the like are arbitrary terms used to refer to one position of an element based on one perspective and should not be construed as limiting the scope of the invention.

It also should be understood that the devices, assemblies, sub-assemblies, materials, constructions, and the like described and illustrated herein represent only some embodiments of the invention. It is appreciated by those skilled in the art that various changes and additions can be made to the devices, assemblies, sub-assemblies, materials, and constructions and the like without departing from the spirit and scope of this invention. It is intended that all such embodiments be covered by the appended claims.

I claim:

1. A chute device for collecting debris, comprising;
a main body panel member having an upper portion and a lower portion, wherein the panel member has a front surface and a rear surface;
an upper rim extending along the upper portion of the panel member and a first side rim that extends downwardly from the upper rim, and an opposing second side rim that extends downwardly from the upper rim, the first and second side rims each having upper and lower sections, wherein the lower section of the first side rim comprises a first handle and the lower section of the second side rim comprises a second handle; and
a lower rim extending along the lower portion of the panel member, wherein at least one attachment clip extends downwardly from the lower rim, and at least one attachment clip extends downwardly from the rear surface of the panel member so that the chute device can be fastened to a container for receiving the debris collected by the chute device.

2. The chute device of claim 1, wherein the lower rim has four attachment clips, and the rear surface of the panel member has one attachment clip.

3. The chute device of claim 2, wherein the attachment clips are removably fastened to the chute.

4. The chute device of claim 1, wherein a debris compactor is removably fastened to the rear surface of the panel member.

5. The chute device of claim 4, wherein the debris compactor comprises a frame having a front surface and a rear surface, the frame having apertures for diffusing air, and a handle extending from the rear surface.

6. The chute device of claim 1, wherein a container handle is removably fastened to front surface of the panel member.

7. The chute device of claim 6, wherein the container handle has upper and lower clamping interfaces for clamping the handle to a container.

8. The chute device of claim 1, wherein the upper rim has a hook and each of the first and second side rims have slots.

9. A chute device and container assembly comprising:
a chute device for collecting debris, the chute device comprising a main body panel member having an upper portion and a lower portion, wherein the panel member has a front surface and a rear surface;
an upper rim extending along the upper portion of the panel member and a first side rim that extends downwardly from the upper rim, and an opposing second side rim that extends downwardly from the upper rim, the first and second side rims each having upper and lower sections, wherein the lower section of the first side rim comprises a first handle and the lower section of the second side rim comprises a second handle;
a lower rim extending along the lower portion of the panel member, wherein at least one attachment clip extends downwardly from the lower rim, and at least one attachment clip extends downwardly from the rear surface of the panel member; and
a container having inner and outer surfaces, wherein the chute is fastened to the container by the attachment clips, that at least one attachment clip extending downwardly from the lower rim and contacting the inner surface of the container, and the at least one attachment clip extending downwardly from the rear surface of the panel member and contacting the outer surface of the container.

10. The chute and container assembly of claim 9, wherein the container is a trash barrel.
